(19) United States
(12) Patent Application Publication
(10) Pub. No.: US 2019/0178269 A1
(43) Pub. Date: Jun. 13, 2019

(54) JOINTED METAL PLATES AND MANUFACTURING METHOD THEREOF

(71) Applicant: Pai-Hsien YANG, Taichung (TW)

(72) Inventor: Pai-Hsien YANG, Taichung (TW)

(21) Appl. No.: 15/870,905

(22) Filed: Jan. 13, 2018

(30) Foreign Application Priority Data
Dec. 8, 2017 (TW) 106143286

(51) Int. Cl. F16B 5/00; F16B 11/00

(52) U.S. Cl. CPC F16B 5/0012; F16B 11/004

(57) ABSTRACT

Jointed metal plates and the manufacturing method thereof are provided, in which a first plate can be end-to-end connected to a second plate. The first plate has protrusions on its jointing edge, while the second plate has recesses on its jointing edge. The protrusions of the first plate are embedded in the recesses of the second plate respectively in a manner that the first plate is fixed with respect to the second plate. Thereby, welding process can be omitted when two metal plates are to be fixed end-to-end. The disadvantages of the welding process can be prevented. The manufacturing efficiency can be increased, while the manufacturing cost can be reduced.

### BACKGROUND OF THE INVENTION

### Field of the Invention

The present invention relates generally to a method for manufacturing a metal plate product and the product thereof, in which multiple plates are jointed end-to-end.

### Description of the Prior Art

Conventional end-to-end metal plate joints are mainly made by welding metal plates. The welded metal plates can be further polished to obtain a smooth jointed surface. Adequate mechanical strength can be achieved.

Nevertheless, there are insurmountable defects for welding technique due to its technical nature. The welding technique can be achieved by melting the edge of one or two jointing metal plates, solidifying the melted parts, and then connecting the plates. Alternatively, another metal can be melted and filled in the gap between two metal plates. No matter which way, melted metal parts are always necessary. In the melting process, metal melting is normally accompanied by high temperature and bright environment, both of which are likely to cause occupational injuries to on-site workers. Besides, high voltage or burning welding gas used for melting metal is also dangerous to the workers. When soldering is utilized, the workpiece will have protruding residual metal on its surface. Polish removal of the metal residuals can easily lead to metal dust, which will endanger the lungs of the workers.

### SUMMARY OF THE INVENTION

One object of the present invention is to provide another way to connect metal plates end-to-end such that the welding techniques can be excluded with a view to improving the health and safety of workers.

To achieve the above and other objects, the present invention provides jointed metal plates including a first plate and a second plate. The first plate includes a first plate member and a plurality of protrusions. The first plate member has a first jointing edge. The protrusions are protruded from the first jointing edge in a jointing direction. The jointing direction coincides with an extension plane of the first plate member. The second plate includes a second plate member and a plurality of recesses. The second plate member has a second jointing edge from which the recesses are recessed in the jointing direction.

To achieve the above and other objects, the present invention provides a manufacturing method for jointed metal plates, which includes a plate cutting step, a stacking step and a stamping step. The plate cutting step is: cutting and obtaining a first plate and a second plate, in which the first plate includes a first plate member and a plurality of protrusions, the first plate member has a first jointing edge, the protrusions are protruded from the first jointing edge in a jointing direction, the jointing direction coincides with an extension plane of the first plate member, the second plate includes a second plate member and a plurality of recesses, the second plate member has a second jointing edge from which the recesses are recessed in the jointing direction. The stacking step is: stacking the first plate on the second plate in a manner that the protrusions abut against the second plate, each of the protrusions covering at least a part of one of the recesses when viewed in a direction perpendicular to the first plate. The stamping step is: after the stacking step, stamping the first plate and the second plate in a manner that the protrusions and the second plate are pressed and partially distorted and that the protrusions are embedded in the recesses respectively, thereby the first plate being fixed with respect to the second plate.

In view of the foregoing, the jointed metal plates and the manufacturing method thereof can connect multiple plates in an end-to-end manner without using welding techniques. Occupational injuries and work safety problems encountered during welding can thus be avoided. The production efficiency and the ease to control the manufacturing cost can also be achieved.

### BRIEF DESCRIPTION OF THE DRAWINGS

FIG. 1 is a schematic view showing the state of use of the jointed metal plates according to the first embodiment of the present invention;

FIG. 2 is a perspective view of the jointed metal plates according to the first embodiment of the present invention;

FIG. 3 is a flow chart of the manufacturing method for the jointed metal plates according to the first embodiment of the present invention;

FIG. 4 is a partial plan view of the jointed metal plates according to the first embodiment of the present invention;

FIG. 5 is a partial profile of the first plate according to the first embodiment of the present invention;

FIG. 6 is a partial perspective view of the first plate according to the first embodiment of the present invention;

FIG. 7 is a partial perspective view of the second plate according to the first embodiment of the present invention;

FIGS. 8-13 are schematic views of the continuous processes of the manufacturing method of the jointed metal plates according to the first embodiment of the present invention;

FIG. 14 is a partial plan view of the jointed metal plates according to the second embodiment of the present invention;

FIG. 15 is a partial perspective view of the jointed metal plates according to the third embodiment of the present invention;

FIG. 16 is a profile taken along the line A-A in FIG. 15.

### DETAILED DESCRIPTION OF THE PREFERRED EMBODIMENTS

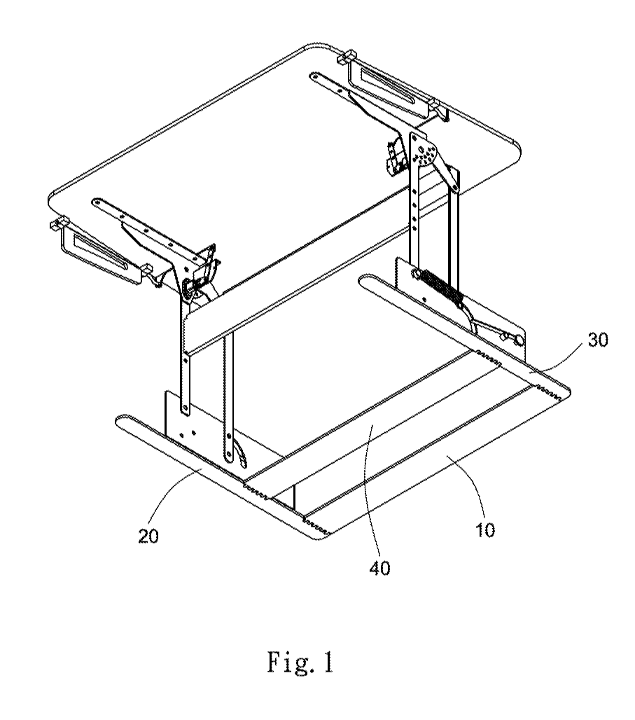

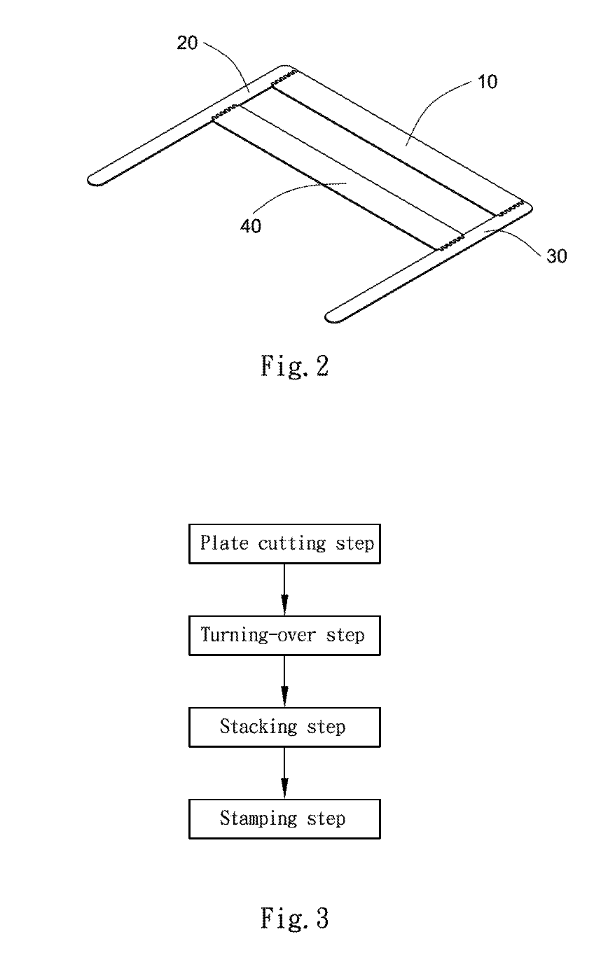

The present embodiment provides a manufacturing method for jointed metal plates. Please refer to FIG. 1, the jointed metal plates may be assembled on the bottom of an adjustable desk or other devices for weighting or as a base. Please refer to FIG. 2, the jointed metal plates of the present embodiment includes a first plate 10, a second plate 20, a third plate 30 and a fourth plate 40 horizontally arranged on the same plane. Theses plates are substantially in rectangular shape, in which the second plate 20 is parallel to the third plate 30 while the first plate 10 and the fourth plate 40 both connect the second plate 20 with the third plate 30. The first plate 10 to the fourth plate 40 as a whole constitutes the jointed metal plates. Four plates are used in the present embodiment and are used as a rectangular base, however other compositions are possible. For instance, a T-shaped base formed by two longitudinal jointing plates is possible. The jointed metal plates can be made by two or more plates. In the present embodiment, every adjacent plates are connected in the same method with similar structures. The first plate and the second plate are exemplary illustrated hereinafter.

Please refer to FIG. 3. The manufacturing method for the jointed metal plates according to the present embodiment includes a plate cutting step, a stacking step and a stamping step, in which an optional turning-over step can be further provided.

The plate cutting step is to cut and obtain the first plate 10 and the second plate 20. Please refer to FIGS. 2 and 4-6. The first plate 10 includes a first plate member 11 and a plurality of protrusions 12. The first plate member 11 has a first jointing edge 111. The protrusions 12 are protruded from the first jointing edge 111 in a jointing direction respectively. The jointing direction is, for example, a direction coincides with an extension plane of the first plate member 11 and perpendicular to the first jointing edge 111 such that the protrusions 12 are respectively protruded in a direction away from the first plate member 11. Each protrusion 12 may include a neck 121 and an engaging portion 122, in which the neck 121 connects the engaging portion 122 to the first plate member 11. The width of each engaging portion 122 is greater than that of its corresponding neck 121 in a width direction, which coincides with the extension plane of the first member 11 and perpendicular to the jointing direction. Thereby the first jointing edge 111 of the first plate member 11 in formed with, along the jointing direction, the protrusive narrow necks 121 and the wide engaging portions 122.

Please refer to FIGS. 2, 4 and 7. The second plate 20 includes a second plate member 21 and a plurality of recesses 22. The second plate member 21 has a second jointing edge 211 from which the recesses 22 are respectively recessed in the jointing direction. The second jointing edge 211 abuts against the first jointing edge 111 and therefore the jointing direction is also perpendicular to the second jointing edge 211. Each recess 22 may include a throat portion 221 and a concave portion 222, in which the throat portion 221 connects the concave portion 222 to the second jointing edge 211. The width of each concave portion 222 is greater than that of its corresponding throat portion 221 in the width direction. That is to say, the second jointing edge 111 of the second plate member 21 is formed with, along the jointing direction, the recessed narrow throat portions 221 and the wide concave portions 222.

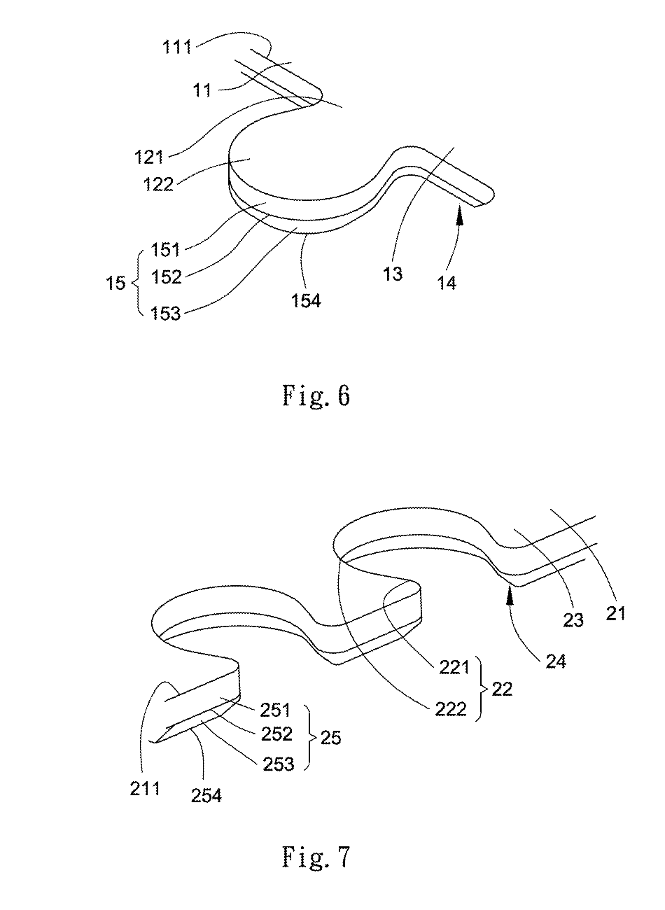

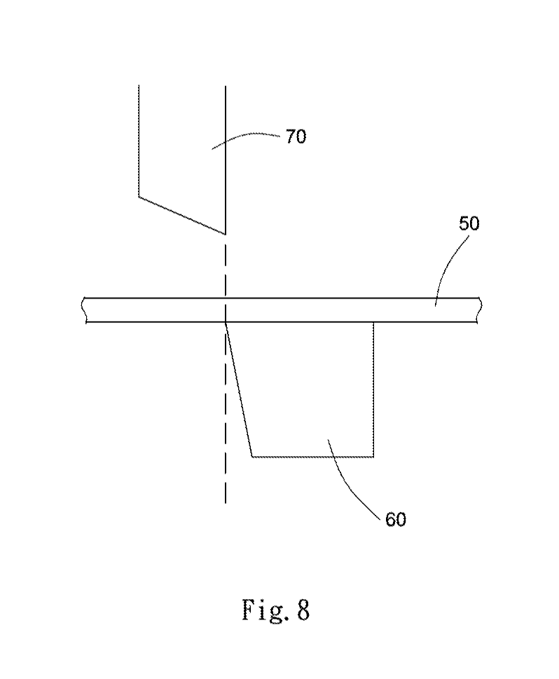

The first plate 10 and the second plate 20 are metal plates, such as low-carbon steel plates. The first and the second plates can be obtained by die-cutting operations in which relatively larger plates are trimmed into the first plate 10 formed with protrusions and the second plate 20 formed with recesses. As shown in FIG. 8, the above-mentioned “die-cutting operations” means that the metal plate 50 is to be cut at a position borne on the edge of a die 60 by a punch 70 moving and punching the metal plate 50 in a cutting direction perpendicular to the metal plate 50 or the first plate. The metal plate 50 can be thus cut into the first plate or the second plate having a predetermined contour. Please refer to FIGS. 6 and 7. The upper surfaces of the first plate 10 and the second plate 20 are punch-in surfaces 13 and 23 where the punch 70 contacts, and the bottom surfaces thereof are punch-out surfaces 14 and 24. The shear areas, especially the protrusions 12 and the recesses 22, between the punch-in surfaces and the punch-out surfaces of the first plate 10 and the second plate 20 include a first side edge 15 and a second side edge 25 respectively. The first side edge 15 includes, sequentially from the punch-in surface 13 to the punch-out surface 14, a first reference surface 151, a first boundary line 152 and a first rupture surface 153. The second side edge 25 includes, sequentially from the punch-in surface 23 to the punch-out surface 24, a second reference surface 251, a second boundary line 252 and a second rupture surface 253. The first reference surface 151 and the second reference surface 251 are substantially perpendicular to the upper surfaces of the first plate 10 and the second plate 20 respectively. The first rupture surface 153 and the second rupture surface 253 are inclined to the first reference surface 151 and the second reference surface 251 respectively, in which an internal obtuse angle is formed between the first rupture surface 153 and the first reference surface 151, and another internal obtuse angle is formed between the first rupture surface 153 and the punch-out surface 14. There is also an internal obtuse angle formed between the second rupture surface 253 and the second reference surface 251, while another internal obtuse angle is formed between the second rupture surface 253 and the punch-out surface 24.

The first rupture surface 153 and the second rupture surface 253 are not necessarily flat, but the first rupture surface 153 and the second rupture surface 253 extend substantially obliquely from the first reference surface 151 and the second reference surface 251 respectively. Therefore the punch-out surfaces of the first plate and the second plate are slightly smaller than the punch-in surfaces thereof respectively. Please refer to FIG. 5, the first rupture surface 153 has an ending edge 154 away from the first reference surface 151. The shortest distance between an extended plane of the first reference surface 151 and the ending edge 154 is 0.4-1 mm, preferably 0.6-0.8 mm. Similarly, the second rupture surface 253 has an ending edge 254 away from the second reference surface 251. The shortest distance between an extended plane of the second reference surface 251 and the ending edge 254 is 0.4-1 mm, preferably 0.6-0.8 mm.

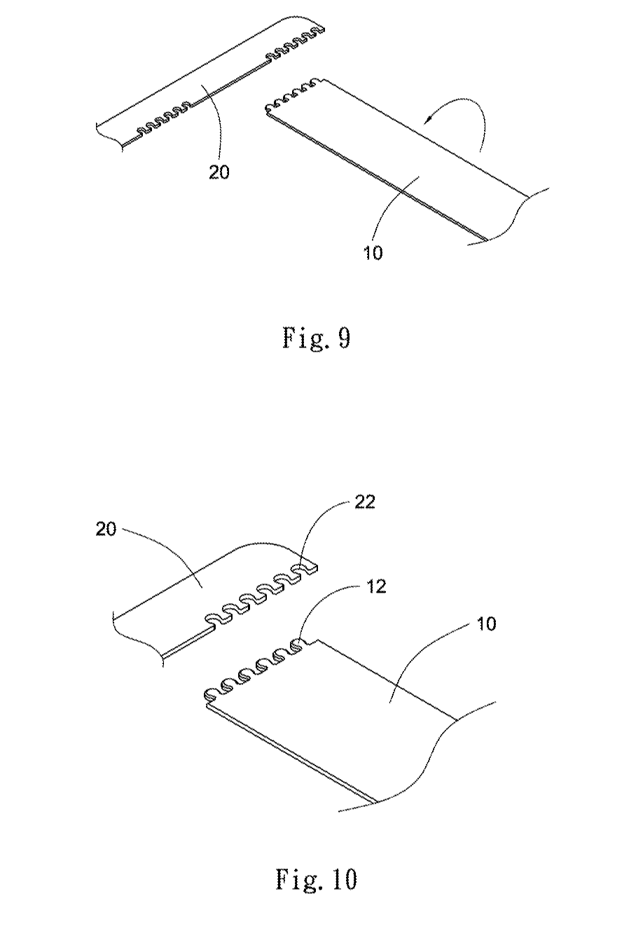

The turning-over step is to flip one of the first plate 10 and the second plate 20 by 180 degrees. For example, as shown in FIG. 9, the first plate 10 is turned 180 degrees, while the second plate 20 is not turned over. Thus the punch-in surface of the first plate 10 faces downward, and the punch-in surfaces of the first plate and the second plate face opposite directions.

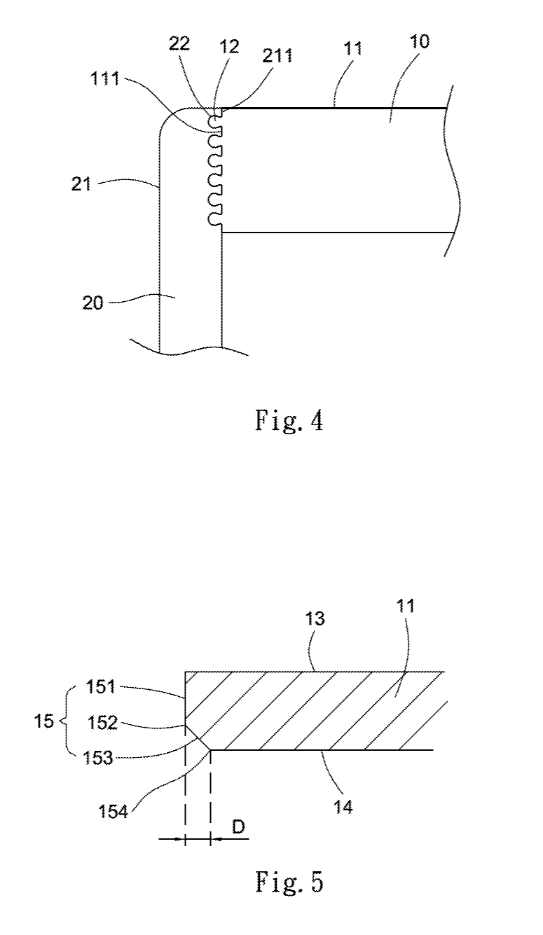

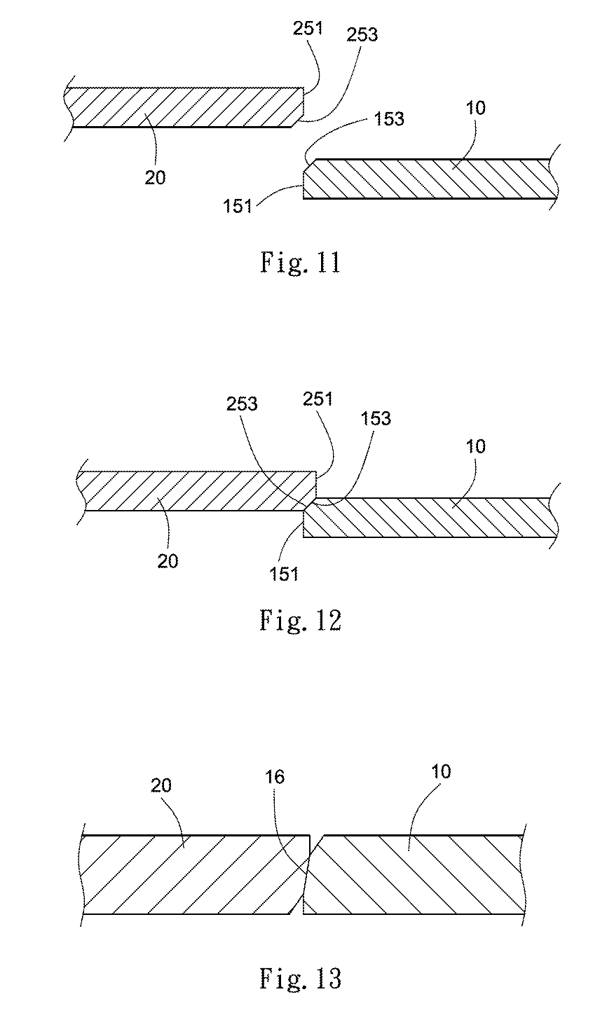

Please refer to FIGS. 10 and 11. The stacking step is to stack the first plate 10 on the second plate 20 in a manner that the protrusions 12 abut against the second plate 20. When viewed in the direction perpendicular to the first plate 10 as shown in FIG. 4, each protrusion 12 covers a portion or all of one of the recesses 22. The dimensions of the first plate 10 and the second plate 20 are designed in the way that the maximum width of each protrusion 12 is greater than that of its corresponding recess 22, while the difference between the maximum width of each protrusion 12 and that of its corresponding recess 22 is 0.8-2 mm, preferably 1.2-1.6 mm. Please refer to FIGS. 10 and 11. After the first plate 10 and the second plate 20 are stacked, the first rupture surface 153 faces and abuts against the second rupture surface 253 as shown in FIG. 12. The protrusions 12 bear against the periphery of the recesses 22 so that the first plate 10 and the second plate 20 cannot separate spontaneously and thus can be further processed. The protrusions 12 have a largest contour at the first reference surface 151 and a smallest contour at the ending edge 154. The recesses 22 have a smallest contour at the second reference surface 252 and a largest contour at the ending edge 254. To stably bear the protrusions 12 against the periphery of the recesses 22, the smaller contour of the protrusions 12 need to be smaller than the largest contour of the recesses 22. To prevent the protrusions 12 from directly falling into the recesses 22, the largest contour of the protrusions 12 need to be larger than the smallest contour of the recesses 22.

In the stamping step, the protrusions 12 and the recesses 22 are cooperated by a stamping operation in a manner that the protrusions 12 and the second plate 20 are pressed and partially distorted, and that the protrusions 12 are embedded in the recesses 22. Thereby the first plate 10 is fixed with respect to the second plate 20. The term “embedding” in the present invention refers to the situation that an object is substantially matched in shape with a space, but is different in size from the space, such that physical interference occurs between the object and another object formed with the space in a manner that the former object tightly fits and is accommodated in the space after the objects are pressed and deformed by an external force. Since the maximum width of each protrusion 12 is 0.8-2 mm larger than that of its corresponding recess 22, the peripheral edges of the protrusions 12 and the recesses 22 deform rapidly and cooperate with each other in the stamping operation. Particularly, the first reference surface on the first side edge and the second reference surface on the second side edge deform in a manner that the protrusions 12 tightly embedded in the recesses 22. Thus the first reference surface contacts the second rupture surface, while the second reference surface contacts the first rupture surface. However, as shown in FIG. 13, deformation surfaces 16 may be generated after the first side edge and the second side edge deform, in which the deformation surfaces 16 are obtained by partial deformation of the reference surfaces and the rupture surfaces.

As shown in FIG. 2, the first plate to the fourth plate can be obtained in the plate cutting step, in which both ends of the first plate and the fourth plate are formed with protrusions, while the second plate and the third plate are formed with recesses. The first plate and the fourth plate can be turned over in the turning-over step without turning the second plate and the third plate. Alternatively, the second plate and the third plate can be turned over in the turning-over step without turning the first plate and the fourth plate. In the stacking step, the first plate to the fourth plate are stacked. In the stamping step, the first plate to the fourth plate are stamped. The jointed metal plates constituted by the first plate to the fourth plate as shown in FIG. 2 are thus obtained.

With the above manufacturing method, the jointed metal plates of the present embodiment can be made from several plates without welding processes. Labor injures and hazards during the welding processes, such as eye diseases caused by welding glare and safety concerns caused by welding gas, can be thus avoided. Additional processing required after the welding, such as the removal of welding residuals, can also be omitted. Processing costs and labor injuries can thus be reduced or mitigated.

In addition, the manufacturing method in the present embodiment utilizes only stamping press machines to complete the processes, which is simple and helps control the production cost.

Compared with the conventional welding processes, the stamping step in the present embodiment can process more plates at a time. The production efficiency can thus be increased while the cost can be lowered.

In some possible embodiment of the present invention, only one of the first side edge and the second side edge is formed with a rupture surface or is shaped otherwise. The turning-over step may be thus omitted from the method for manufacturing the jointed metal plates.

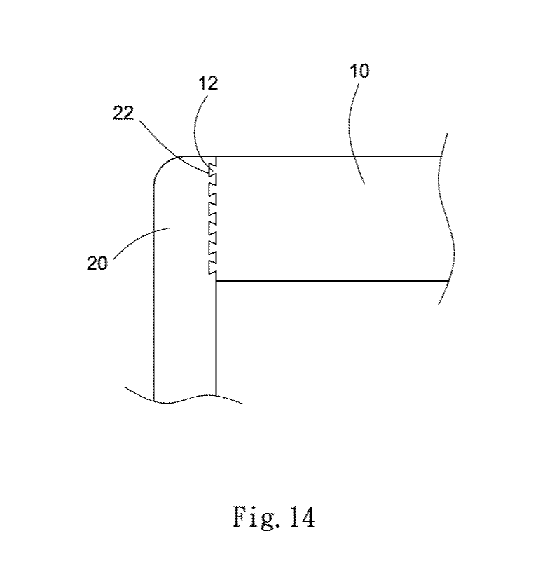

In the afore-mentioned embodiment, the contours of the protrusions and the recesses are substantially arc-shaped, however they can also be shaped otherwise. For instance, the embodiment as shown in FIG. 14 discloses that the protrusions and the recesses can be changed into the trapezoidal shape Similar jointing effect to the prior embodiment can be obtained.

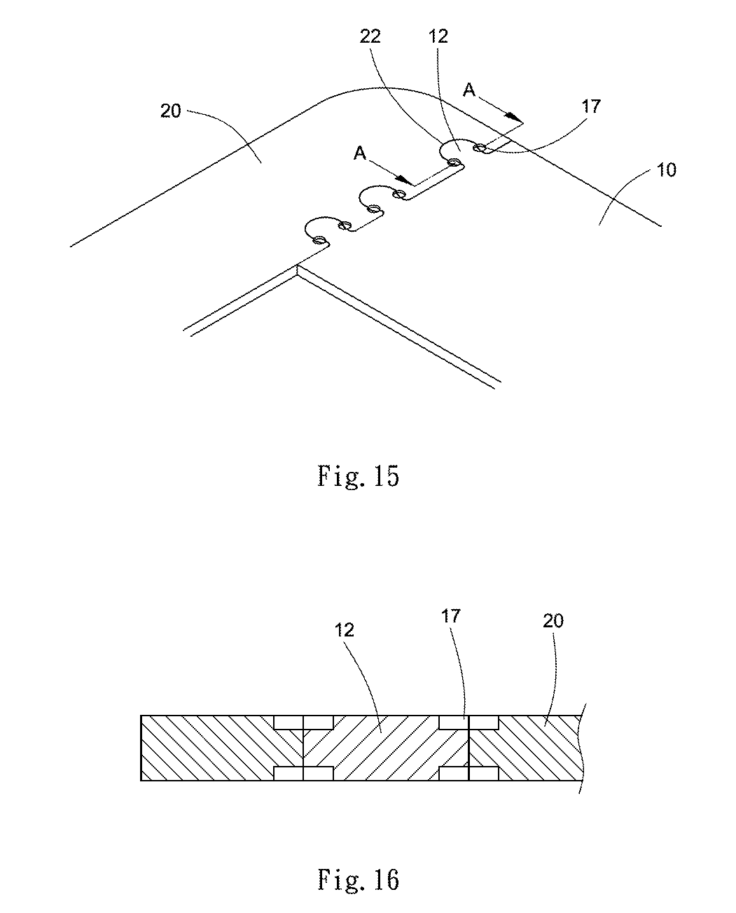

Please refer to FIGS. 15 and 16 for the third embodiment of the present invention. The manufacturing method the jointed metal plates of the present embodiment is similar to that of the first embodiment. The jointed metal plates can be further pressed to form recessed notches 17 across the surfaces of the protrusions 12 and the second plate 20. Such deformation helps the protrusions 12 fit more tightly with the recesses 22 to improve the jointing strength between the first plate 10 and the second plate 20. The depth of the notches can be between 0.6-0.8 mm.

In view of the above, the manufacturing method for jointed metal plates provided by the present invention can replace the welding process by the stamping process during the end-to-end jointing of the metal plates, which not only reduces the occupational injuries of on-site workers but also helps control costs and increase production efficiency.

What is claimed is:

1. Jointed metal plates comprising:
a first plate, comprising a first plate member and a plurality of protrusions, the first plate member having a first jointing edge, the protrusions being protruded from the first jointing edge in a jointing direction, the jointing direction coinciding an extension plane of the first plate member; and
a second plate, comprising a second plate member and a plurality of recesses, the second plate member having a second jointing edge from which the recesses are recessed in the jointing direction;
wherein the protrusions are engaged with the recesses respectively in a manner that the first plate is fixed with respect to the second plate.

2. The jointed metal plates of claim 1, wherein the protrusions each has a neck and an engaging portion, the neck of each of the protrusions connects its corresponding engaging portion to the first plate member, a width of each of the engaging portions is larger than that of its corresponding neck in a width direction, which is perpendicular to the jointing direction and coincides with the extension plane of the first plate member, the recesses each has a throat portion and a concave portion, the throat portion of each of the recesses connects its corresponding concave portion to the second jointing edge, a width of each of the concave portion is larger than that of its corresponding throat portion in the width direction.

3. The jointed metal plates of claim 1, wherein the first plate and the second plate each has an upper surface and a bottom surface, the protrusions as a whole has a first side edge, the first side edge comprises a first reference surface and a first rupture surface, the first reference surface is perpendicular and connected to the upper surface of the first plate, the first rupture surface is connected to the bottom surface of the first plate, there is an internal obtuse angle between the first rupture surface and the first reference surface, the recesses as a whole has a second side edge, the second side edge comprises a second reference surface and a second rupture surface, the second reference surface is perpendicular and connected to the upper surface of the second plate, the second rupture surface is connected to the bottom surface of the second plate, there is an internal obtuse angle between the second rupture surface and the second reference surface, the first reference surface is in contact with the second rupture surface, the first rupture surface is in contact with the second reference surface.

4. A manufacturing method for jointed metal plates, comprising the following steps:
a plate cutting step: cutting and obtaining a first plate and a second plate, wherein the first plate comprises a first plate member and a plurality of protrusions, the first plate member has a first jointing edge, the protrusions are protruded from the first jointing edge in a jointing direction, the jointing direction coincides with an extension plane of the first plate member, the second plate comprises a second plate member and a plurality of recesses, the second plate member has a second jointing edge from which the recesses are recessed in the jointing direction;
a stacking step: stacking the first plate on the second plate in a manner that the protrusions abut against the second plate, each of the protrusions covering at least a part of one of the recesses when viewed in a direction perpendicular to the first plate;
a stamping step: after the stacking step, stamping the first plate and the second plate in a manner that the protrusions and the second plate are pressed and partially distorted and that the protrusions are embedded in the recesses respectively, thereby the first plate being fixed with respect to the second plate.

5. The manufacturing method of claim 4, wherein the protrusions each has a neck and an engaging portion, the neck of each of the protrusions connects its corresponding engaging portion to the first plate member, a width of each of the engaging portions is larger than that of its corresponding neck in a width direction, which is perpendicular to the jointing direction and coincides with the extension plane of the first plate member, the recesses each has a throat portion and a concave portion, the throat portion of each of the recesses connects its corresponding concave portion to the second jointing edge, a width of each of the concave portion is larger than that of its corresponding throat portion in the width direction, after the stamping step, the engaging portions are embedded in the concave portions respectively.

6. The manufacturing method of claim 4, wherein in the plate cutting step, the first plate and the second plate are obtained by die-cutting operations in a cutting direction, a turning-over step is further provided between the plate cutting step and the stamping step in which the turning-over step is performed by flipping one of the first plate and the second plate by 180 degrees.

7. The manufacturing method of claim 4, wherein the first plate and the second plate each has an upper surface and a bottom surface, the protrusions as a whole has a first side edge, the first side edge comprises a first reference surface and a first rupture surface, the first reference surface is perpendicular and connected to the upper surface of the first plate, the first rupture surface is connected to the bottom surface of the first plate, there is an internal obtuse angle between the first rupture surface and the first reference surface, the recesses as a whole has a second side edge, the second side edge comprises a second reference surface and a second rupture surface, the second reference surface is perpendicular and connected to the upper surface of the second plate, the second rupture surface is connected to the bottom surface of the second plate, there is an internal obtuse angle between the second rupture surface and the second reference surface, the first reference surface is in contact with the second rupture surface, the first rupture surface is in contact with the second reference surface.

8. The manufacturing method of claim 7, wherein before the stamping step, the maximum width of each of the protrusions is greater than that of its corresponding recess, and the difference between the maximum width of each of the protrusions and that of its corresponding recess is 0.8-2 mm.

9. The manufacturing method of claim 8, wherein the first rupture surface has an ending edge away from the first reference surface, the shortest distance between an extended plane of the first reference surface and the ending edge is 0.4-1 mm.

10. The manufacturing method of claim 4, wherein after the protrusions are embedded in the recesses respectively, recessed notches are formed and extended across the protrusions and the second plate respectively.
